(19) United States
(12) Patent Application Publication
(10) Pub. No.: US 2025/0141230 A1
(43) Pub. Date: May 1, 2025

(54) System and Method for Battery Source Integration and Utilization with Utility Power

(71) Applicant: Patterson-UTI Drilling Company LLC, Houston, TX (US)

(72) Inventors: Marcel Snijder Van Wissenkerke, Houston, TX (US); Ronald Barbee, Houston, TX (US); Nathaniel Norris, Houston, TX (US); Syed Tilal, Houston, TX (US)

(21) Appl. No.: 19/007,068

(22) Filed: Dec. 31, 2024

Related U.S. Application Data
(63) Continuation-in-part of application No. 18/373,646, filed on Sep. 27, 2023.
(63) Continuation-in-part of application No. 18/307,399, filed on Apr. 26, 2023, now Pat. No. 12,215,573.

(51) Int. Cl. H02J 3/32; H02J 3/46; H02J 7/00

(52) U.S. Cl. CPC H02J 3/32; H02J 3/466; H02J 7/00032; H02J 7/0048; H02J 7/0063; H02J 2300/10; H02J 2300/40

(57) ABSTRACT

This disclosure provides methods, components, devices and systems for battery power source integration and utilization at a drilling site by adjusting power draw from various power sources based on conditions at the drilling site. Some aspects, more specifically, relate to supplying power to the drilling site using a utility power source, where the utility power source includes a utility setpoint. During this period, detection of an increase in power demand may occur at the drilling site. The increase in the power demand can include a load ramp indicating a rate which the power demand increases over a period of time. Based on the power demand and load ramp, as well as the utility setpoint, embodiments may supply additional power to the drilling site using a battery power source.

### CROSS-REFERENCE TO RELATED APPLICATIONS

This application is a continuation-in-part of U.S. patent application Ser. No. 18/373,646, filed Sep. 27, 2023, and entitled “Method and System for Blackout Prevention on a Drilling Rig,” and is also a continuation-in-part of application Ser. No. 18/307,399, filed Apr. 26, 2023 and entitled “Method and System for Stealth Mode Operation of a Drilling Rig” which is assigned to the assignee hereof and the disclosure of each of which is incorporated by reference in their entirety herein.

### BACKGROUND

This disclosure relates generally to oil well drilling and, more specifically, optimizing battery source utilization at a drilling site by automatically adjusting power draw from various power sources based on conditions at the site.

Powering an oil well site involves providing the necessary electrical and mechanical energy to operate various equipment and systems essential for drilling, production, and safety. Oil well site power sources typically include diesel generators, natural gas generators, utility power, solar panels, wind turbines, and, more recently, batteries. Batteries can store energy generated from primary and renewable sources, providing power during demand surges, spikes, or outages.

During operation, powering an oil well site can be accomplished with a combination of generators and utility power that involves integrating multiple power sources to ensure a reliable and continuous supply of electricity for all operational needs. A power management system (PMS) can be used to integrate and manage different power sources by balancing the load between the utility-provided power and generators and distributing power based on current demand and availability.

### SUMMARY

The systems, methods, and devices of this disclosure each have several innovative aspects, no single one of which is solely responsible for the desirable attributes disclosed herein.

One innovative aspect of the subject matter described in this disclosure can be implemented as a method for battery power source integration and utilization at a drilling site by adjusting power draws from various power sources based on conditions at the drilling site. The method, more specifically, includes supplying power to the drilling site using a utility power source, where the utility power source includes a utility setpoint, which can be based on an amount of available utility power. The method also includes detecting an increase in power demand occurring at the drilling site. The increase in the power demand can include a load ramp indicating a rate at which the power demand increases over a period of time. Based on the power demand and load ramp, as well as the utility setpoint, the method further includes supplying additional power to the drilling site using a battery power source. In some implementations, the method includes placing the battery into charging mode and unloading the generator when a drop in the power demand occurs. Thus, the power that would have gone back to the utility power source is used to charge the battery power source instead.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The systems, methods, and devices of this disclosure each have several innovative aspects, no single one of which is solely responsible for the desirable attributes disclosed herein.

FIG. 1 illustrates a diagram of a drilling site environment for performing drilling operations, in accordance with embodiments of the present disclosure.

FIG. 2 illustrates a diagram of a power source orchestration system for implementing a battery power source in a drilling site environment, in accordance with embodiments of the present disclosure.

FIG. 3 illustrates a diagram of a power management system for integrating a power source orchestration system, in accordance with embodiments of the present disclosure.

FIG. 4 illustrates a flowchart for implementing a battery power source in a drilling site environment, in accordance with embodiments of the present disclosure.

FIG. 5 illustrates a flowchart for implementing a battery power source and generator power in a drilling site environment, in accordance with embodiments of the present disclosure.

FIG. 6 illustrates a schematic diagram of an exemplary environment in which a power source orchestration system can operate, in accordance with embodiments of the present disclosure.

FIG. 7 illustrates a block diagram of an exemplary computing device, in accordance with embodiments of the present disclosure.

While the present disclosure is amenable to various modifications and alternative forms, specifics thereof, have been shown by way of example in the drawings and will be described in detail. It should be understood, however, that the intention is not to limit the particular embodiments described. On the contrary, the intention is to cover all modifications, equivalents, and alternatives falling within the scope of the present disclosure. Like reference numerals are used to designate like parts in the accompanying drawings.

### DETAILED DESCRIPTION

This disclosure relates generally to oil well drilling and, more specifically, to optimizing battery source utilization at a drilling site by automatically adjusting power draw from various power sources based on conditions at the site. The following description is directed to some particular examples for the purpose of describing innovative aspects of this disclosure. However, a person having ordinary skill in the art will readily recognize that the teachings herein can be applied in a multitude of different ways.

Powering a drilling site can involve a combination of traditional and modern energy sources to ensure a continuous and reliable supply of electricity necessary for drilling operations. The power requirements are substantial, given the need to operate heavy machinery, lighting, and various equipment essential for drilling and safety. Primary power sources at a drilling site include diesel, natural gas generators, and utility power.

Diesel generators are the most common power source at drilling sites, especially in remote locations. These generators convert diesel fuel into electrical energy, which is then distributed throughout the site. They can power critical systems such as the hoisting mechanism, rotary drill systems, pumps, and site lighting. Similarly, natural gas generators utilize natural gas to produce electricity, which can be connected to the site's natural gas supply to power the generators. When a drilling site is located near existing power infrastructure, electricity from the local utility power grid can be used. Utility power offers a reliable and often more cost-effective source of electricity. It can either supplement or replace on-site generators.

Batteries are increasingly being integrated into the power systems of drilling sites to provide a reliable and flexible source of energy. Batteries store electrical energy generated from primary sources (e.g., diesel generators, natural gas generators, utility power) and release that energy when needed. The batteries can serve to smooth out fluctuations in power supply, provide backup power during outages, and support critical operations during peak demand periods or generator maintenance. These features and flexibility improve the efficiency of the generators by increasing the average generator load, load leveling, and peak shaving. When demand spikes, the battery supplies the excess power, preventing generators from having to ramp up to meet short-term peaks and allowing the rig to operate with fewer online generators.

Battery Management Systems (BMS) are typically used to monitor and manage battery performance, ensuring safe and efficient operation. The BMS can control charging and discharging cycles, balance cells, and protect against overcharging, overheating, and other potential issues. This system can be integrated with the site's power management system to coordinate with generators and other power sources to provide seamless energy flow and optimal resource utilization.

The Power Management Systems (PMS), as discussed, are used to monitor and manage power distribution across a drill site. These systems provide continuous monitoring of power systems to detect issues and facilitate timely maintenance, thereby reducing downtime and operational risks. By integrating various power sources and employing smart grid technologies, drilling sites can optimize fuel use, reducing costs and environmental impact.

Limitations on battery utilization remain, however, as integrating batteries with existing power systems can be complex as batteries have finite storage capacities that may limit their ability to meet high or prolonged energy demands. Batteries may deplete quickly during peak usage or during extended periods without primary power sources, necessitating careful energy management that may lead to power shortages. Also, improper battery discharge can lead to faster battery degradation, reducing capacity and efficiency. This degradation necessitates regular monitoring, maintenance, and eventual replacement of batteries, which may impact the long-term reliability and cost-effectiveness of battery systems.

Various aspects of the disclosure improve existing technologies, as well as others, by providing methods, components, and systems that support battery power source integration within a drilling site. The improved technologies optimize battery source utilization at the drilling site by automatically adjusting power drawn from various power sources based on conditions at the site. These aspects can aid in providing additional power from the battery power source when power drawn from a utility power source approaches, exceeds, or may exceed its utility setpoint. As power demand increases and a load ramp rate indicates that the utility power source may exceed its utility setpoint, additional power from the battery power source can be provided to the drilling site.

In some implementations, generators can also provide generator power where the generators are configured with a base load having a generator setpoint. The generators can provide the drilling site with generator power based on the setpoint. When there is a decrease in power demand, the generator setpoint can be lowered, and when there is an increase in demand, the setpoint can be increased. Additionally, the setpoint can be set to operate in conjunction with the battery power source and the utility power source so that the utility power source does not exceed its utility setpoint.

Particular aspects of the subject matter described in this disclosure can be implemented to realize one or more of the following potential advantages. The present disclosure aims to provide real-time and automated power draw adjustments that optimize the utilization of battery power sources at a drilling site during operation. Implementation of these mechanisms ensures sufficient power is provided to a drilling site while avoiding power draw from the utility power source exceeding its utility setpoint. By providing a battery power source to a drilling site, power management systems can quickly and efficiently meet power demands, as demand can rapidly increase or decrease based on the operation and utilization of equipment at the drilling site. As an example, additional power from a battery power source can be utilized as power demand rapidly increases, and the ramp rate indicates that the power produced from the utility power source may or will exceed its utility setpoint. This additional power can expeditiously support the rapid increase in demand nearly instantaneously as opposed to the delayed response provided by generators.

### Example Drilling Site Environment

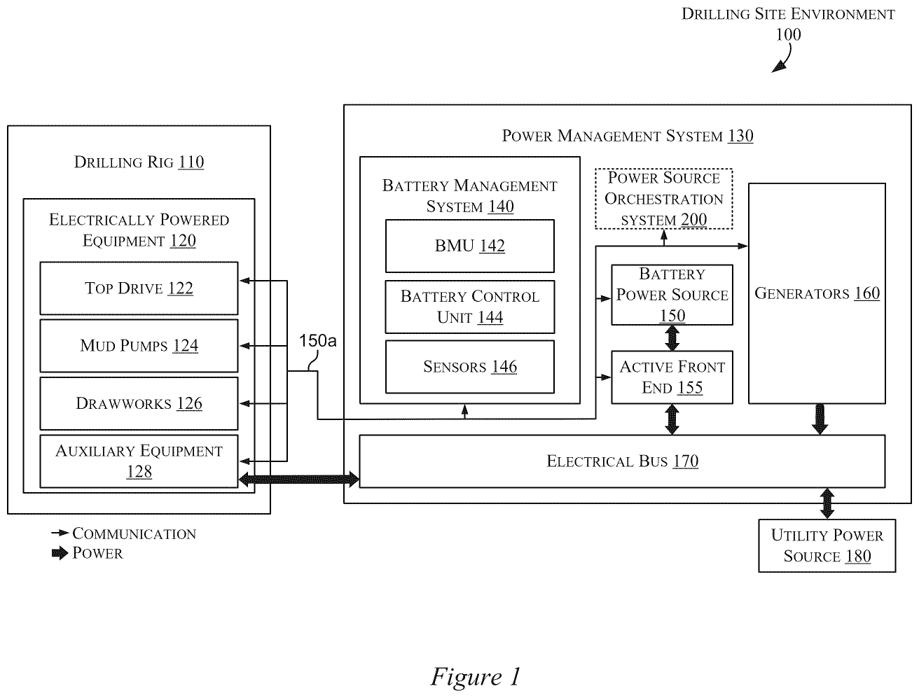

Referring now to FIG. 1, a block diagram of an example drilling site environment 100 suitable for use in implementing embodiments of the disclosure is shown. The drilling site environment 100 is an environment with a combination of heavy machinery and specialized equipment that perform operations to extract resources from beneath the earth's surface. As shown, the drilling site environment 100 includes a drilling rig 110 with electrically powered equipment 120, including a top drive 122, mud pumps 124, drawworks 126, and auxiliary equipment 128. The drilling site environment 100 also includes a power management system 130, a battery management system 140, a battery power source 150, an active front end 155, generators 160, an electrical bus 170, and a utility power source 180. The battery management system 140 includes a battery monitoring unit 142 and sensors 146. The drilling site environment 100 can also include a power source orchestration system 200.

The drilling rig 110 is a component of the drilling site environment 100, including a derrick or mast, which supports the drilling equipment and hoisting systems. The drilling rig 110 can house the drill bit, drill string, and other essential components used to bore into the earth. The drilling rig 110 can also include systems for circulating drilling mud and controlling pressure. As an example, and as shown, the drilling rig 110 includes a top drive 122, one or more mud pumps 124, drawworks 126, and auxiliary equipment 128.

The top drive 122 is a piece of drilling equipment used to rotate the drill string during the drilling process that is mounted on the derrick or mast of the drilling rig 110. The mud pumps 124 are used to circulate drilling mud (drilling fluid) down the drill string, through the drill bit, and back up the well bore to the surface. The drawworks 126 is the primary hoisting mechanism on the drilling rig 110, used to raise and lower the drill string and other equipment in and out of the wellbore. The auxiliary equipment 128 provides support for various drilling operations and ensures the smooth and safe functioning of the drilling rig 110.

The electrical power draw of the electrically powered equipment 120 on the drilling rig 110 can vary significantly depending on the size and capacity of the drilling rig 110, as well as the specific operational requirements. For instance, power drawn from the top drive 122 can depend on the drilling depth, the rotational speed and torque, and the operational mode (e.g., normal drilling, tripping, connections).

In some implementations, one or more of the electrically powered equipment 120 installed on the drilling rig 110 provides data for monitoring activity. For example, the data may include parameters of the equipment (e.g., minimum, maximum, optimal, and/or user-defined power levels), real-time load information (e.g., streaming time series data), or anticipated load information (e.g., upcoming load estimates, scheduled activation times).

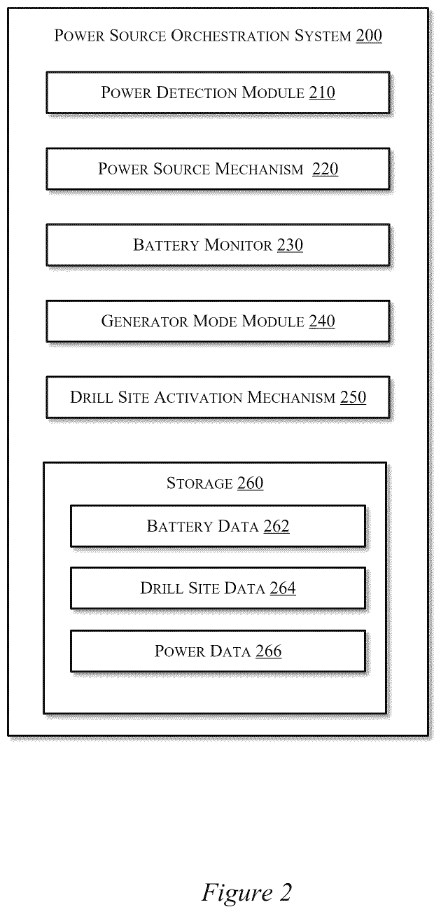

The power management system 130 is a component of the drilling site environment 100 configured to distribute electrical power to all the necessary equipment (e.g., the drilling rig 110, the electrically powered equipment 120, the battery power source 150) and operations. The power management system 130 includes the battery management system 140, which includes a battery monitoring unit 142, a battery control unit 144, and sensors 146. The power management system 130 also includes the battery power source 150, the active front end 155, the generators 160, and the electrical bus 170. In some implementations, the power management system 130 includes the power source orchestration system 200, as described below with reference to FIG. 2.

The battery management system 140 is a component of the power management system 130 configured to monitor, manage, and protect the battery power source 150 at the drilling site environment 100. The battery management system 140 can include a battery monitoring unit 142, a battery control unit 144, and sensors 146. The battery monitoring unit 142 can continuously monitor the state of each battery cell associated with the battery power source 150, including voltage, current, and temperature. The sensors 146 and data acquisition modules can collect real-time data from the battery cells and provide that information to the battery monitoring unit.

The battery control unit 144 is configured to manage the charging and discharging process, ensuring proper performance and longevity of the battery power source 150. Microcontrollers and processors can execute algorithms based on data from the battery monitoring unit 142 and other sources to manage the charge and discharge of power from the battery power source 150.

The battery power source 150 is a component of the power management system 130 that includes a plurality of battery cells connected in a network (e.g., a plurality of battery cells may be connected in series as a battery pack to achieve a predetermined output voltage level, a plurality of battery cells or battery packs may be connected in parallel to achieve a predetermined current output current level). The battery power source 150 may be configured with any power ratings (e.g., input/output capacity, lifetime, power storage capacity). The battery power source 150 may be of any type that is suitable for repeated charge/discharge cycles. Lithium-ion batteries or other any other appropriate battery chemistry or battery technology may be used.

In some implementations, the battery power source 150 includes additional subsystems (e.g., a battery management system 140, one or more programmable logic controllers) to monitor and maintain the individual battery cells (e.g., active protection by performing diagnostics based on temperature, voltage, and current monitoring). Furthermore, the battery power source 150 may include one or more passive protections (e.g., fuses, breakers, mechanical protections).

The battery power source 150 may be configured as a standalone battery system, an uninterruptible power supply system, a hybrid power system, a battery energy storage system, starting batteries, grid-tied battery systems, deep cycle batteries, modular battery systems, redox flow batteries, or any combination thereof. For example, grid-tied battery systems allow the battery power source 150 to charge its batteries from the grid and store the energy until called upon.

The active front end 155 is a component of the power management system 130 configured to enable bi-directional power flow, allowing energy to move both into and out of the battery power source 150. The active front end can include one or more bi-directional power inverters configured to charge and discharge the battery power source 155 via the electrical bus 170. The active front end 155 may include any type of AC/DC converter.

In some implementations, the active front end 155 supports the electrical bus 170 with capacitive and inductive reactive power to provide complete control of the exchange between the battery power source 150 and the electrical bus 170. The active front end 155 may have any power ratings (e.g., input/output capacity, volt-ampere rating, apparent power rating). In some implementations, the active front end 155 may mimic the power rating of a generator 160 to use the same connection to the electrical bus 170. The active front end 155 is further configured to come equipped with passive and/or active subsystems to maintain the power inverters (e.g., physical enclosures, liquid cooling systems, environmental controls).

It should be noted that while FIG. 1 only shows a single battery power source 150 and a single active front end 155, any number may be used. In some implementations, the power management system 130 on a drilling rig 110 may be equipped with multiple generators 160 that are supported by one or more battery power sources 150 and one or more active front ends 155. In some implementations, the active front end 155 may have similar power ratings as a generator 160, such that the battery power source 150 and the active front end 155 take the place of a generator 160 without significant retrofitting.

The generator(s) 160 are components of the power management system 130 configured as a source of power within the drilling site environment 100. In various implementations, the generator 160 can be a diesel generator, a natural gas generator, a dual fuel generator, a hydraulic generator, a steam turbine generator, a turbine generator, and the like. While FIG. 1 only shows a single generator, any number of generators of any size and type may be used. For example, a drilling site environment 100 may be equipped with three generators 160, four generators 160, or any number needed to meet the power demands necessary to operate a corresponding drilling rig 110.

The power management system 130 powers the drilling rig 110 with an electrical bus 170. The electrical bus 170 may include a three-phase AC bus with any voltage used by the electrically powered equipment. The electrical bus 170 may further include a DC bus with any voltage used by the electrically powered equipment. Any type of electrical bus may be used without departing from the disclosure. In the power management system 130, in addition to interfacing with one or more generators 160, the electrical bus 170 interfaces with the battery power source 150 via the active front end 155. In one or more embodiments, the electrical bus 170 may be further configured to interface with a utility power source 180 (e.g., including an additional interface to receive power from or exchange power with a commercial AC grid).

In some implementations, when demand from the drilling rig 110 is lower than the output capacity of the generator(s) 160 or the output capacity of the utility power source 180, the power management system 130 may control the active front end 155 to use the remaining power production capacity of one or more of those power sources charge the battery power source 150.

The power management system 130 is further configured to communicate with the generator(s) 160, the battery power source 150, and the active front end 155 via a network 150a. Furthermore, the power management system 130 may communicate with the drilling rig 110 via the network 150a. The network 150a may connect to a controller (not shown) on the drilling rig 110 or directly to specific pieces of electrically powered equipment on the drilling rig 110 (e.g., a top drive 122, a mud pump 124, a drawworks 126, and/or a piece of auxiliary equipment 128). In other words, the power management system 130 may receive information related to the operations of the drilling rig 110 (e.g., operational parameters, power demand information, status information, or any other appropriate data) via the network 150a.

The network 150a may be a wired or wireless network (e.g., a local area network (LAN), a wide area network (WAN) such as the Internet, mobile network, or any other type of network) and implemented via one or more network interface connections (e.g., a structural transceiver such as a communication port or antenna) (not shown). The network 150a may include a variety of communication networks (e.g., CANbus, Modbus, Discrete/Analog inputs) that are integrated with the power management system 130. In one of more embodiments, the power management system 130 may use an Industrial Internet of Things (IIoT) application to access and exchange information from any point of the drilling site environment 100. Data may be streamed online for operators and service providers to monitor in real-time.

It is noted that FIG. 1 is intended to depict the major representative components of a drilling site environment 100. In some embodiments, however, individual components may have greater or lesser complexity than, as represented in FIG. 1, components other than or in addition to those shown in FIG. 1 may be present, and the number, type, and configuration of such components may vary.

### Example Power Source Orchestration System

Referring now to FIG. 2, a block diagram of an example power source orchestration system 200 suitable for use in implementing embodiments of the disclosure is shown. The power source orchestration system 200 is configured to optimize battery source utilization at a drilling site by automatically adjusting power draw from various power sources based on conditions at the site. In conjunction with algorithms, the power source orchestration system 200 can utilize drilling rig data, battery status, condition information, and power demands to provide additional power from battery sources to supplement utility-provided power. The power source orchestration system 200 first supplies power to a drilling site using a utility power source. The utility power source includes a utility setpoint that can set the maximum power draw allowed from the utility power source. While the drilling site is supplied with power from the utility power source, the power source orchestration system 200 can detect an increase in power demand to the drilling site. The increase in power demand typically includes a load ramp, indicating a rate at which the power demand increases over a period of time. In order to avoid having the utility power source exceed its utility setpoint, the power source orchestration system 200 can supply additional power to the drilling site using the battery power source. The supplemental energy can be based on the load ramp, indicating that the power demand may or will cause the utility setpoint to be exceeded. Thus, the power source orchestration system 200 ensures the setpoint is adhered to while also providing the necessary power required to operate a drilling site.

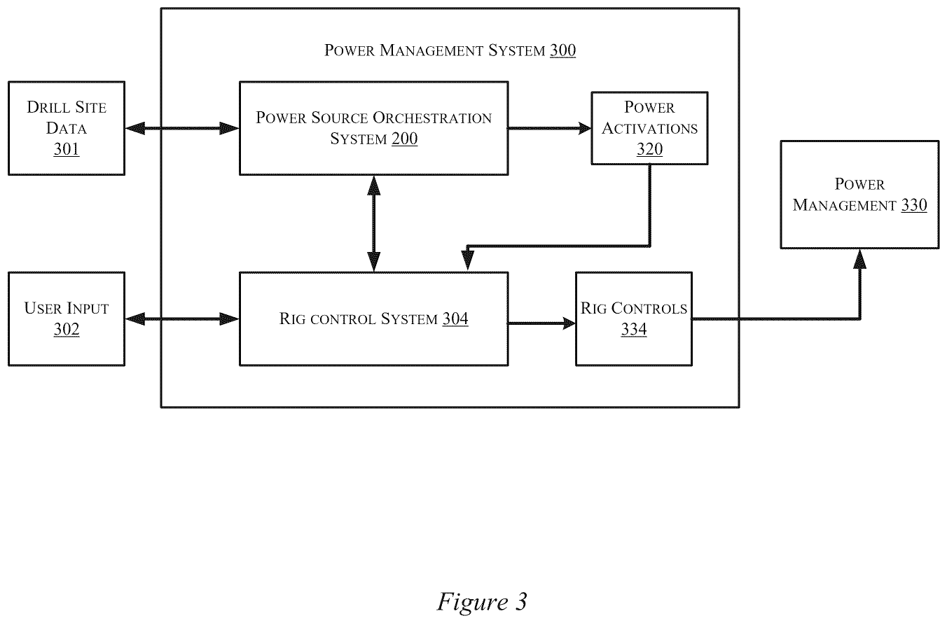

The power source orchestration system 200 can be implemented as a standalone application or as part of another application or suite of applications. For example, the power source orchestration system 200 can be implemented as part of a power management system which can be substantially similar to the power management system 130 with reference to FIG. 1, or power management application, enabling the power orchestration of power sources to be a module of the power management application. The power source orchestration system 200 implemented as part of another application is further described in more detail in FIG. 3.

The power source orchestration system 200 includes a power detection module 210, a power source mechanism 220, a battery monitor 230, a generator mode module 240, a drill site activation mechanism 250, and storage 260. The storage 260 includes battery data 262, drill site data 264, and power data 266.

The power detection module 210 is a component of the power source orchestration system 200 configured to detect the power sources connected to a drilling site and their respective configurations. In some implementations, the power detection module 210 utilizes various sensors and detectors to measure parameters such as voltage, current, frequency, and power factor from the power sources connected to the drilling site. The data collected from the power sources (e.g., the battery power source, the generator, the utility power source) can be analyzed by the power detection module 210 to determine the status of each power source.

In some implementations, the power detection module 210 continuously monitors all power sources at the drilling site, including the generators, any backup generators, battery power sources, renewable energy systems (if available), and utility power sources. Data can be collected in real-time from the sensors and continuously analyzed to ensure the up-to-date status of each power source.

The power detection module 210 is further configured to identify which power sources are currently active and supply power to the drilling site. In some implementations, the power detection module 210 can detect transitions between power sources, such as when a generator starts due to an increase in power demand.

The power detection module 210 is further configured to collect data from power meters and sensors configured to measure electrical parameters such as voltage, current, and power consumption of electrically powered equipment operating within the drilling site. The power detection module 210 can use the collected data to assess power demand, and algorithms and models can be used to predict future power demand based on current and historical data. In some implementations, power demand is calculated by aggregating the power usage of all connected equipment and systems. Additionally, the power detection module 210 can identify patterns and trends in power consumption, such as peak usage times, average demand, and any sudden spikes or drops in power usage.

The power detection module 210 is further configured to calculate the load ramp at a drilling site by determining the rate at which power demand increases or decreases over a specific period of time. Power meters can continuously measure the power consumption of the drilling site's equipment and systems, and the associated data can be collected by the power detection module 210 at a regular interval. A predefined time interval may be used over which the load ramp is calculated. This time interval can be short-term (e.g., 10 milliseconds (ms), 100 ms, 1 second) or long-term (e.g., (30 seconds, 1 minute, 10 minutes, hourly, etc). The load ramp can then be calculated as the rate of change in power consumption over the defined time intervals. In some implementations, the load ramp is calculated using Equation 1 as follows:

$$Load Ramp = \frac{Δ P}{Δ t}$$

Where ΔP is the change in power consumption, and Δt is the change in time. In some implementations, the power detection module 210 analyzes the load ramp to identify trends in power consumption that may identify load behaviors, peak demand periods, and periods of rapid load changes.

The power source mechanism 220 is a component of the power source orchestration system 200 configured to activate power sources to supply power to the drilling site. In some implementations, based on the load ramp and a utility setpoint, the power source mechanism 220 can activate a battery power source to supply additional power to a drilling site to meet the demand anticipated by the load ramp. While the power demand indicates that it will exceed, or has exceeded, the utility setpoint, the power source mechanism 220 can continue to supply additional power to the drilling site equivalent to or similar to the amount of power demand that exceeds the utility setpoint or the amount of power demand that prevent the power demand from exceeding the utility setpoint. The additional power may allow the utility power source to supply power to the drilling site at the utility setpoint without exceeding the setpoint. Therefore, the power provided to the drilling site meets the power demand while avoiding exceeding the utility setpoint.

In some implementations, the power detection module 210 detects a decrease in power demand such that the overall power demand is below the utility setpoint. When power demand is decreased, in such cases, the power source mechanism 220 can stop supplying additional power from the battery power source. In some implementations, the power detection module 210 may utilize the excess power availability to charge the batteries associated with the battery power source.

The battery monitor 230 is a component of the power source orchestration system 200 configured to monitor the status of the battery power source associated with the drilling site. In some implementations, the battery monitor 230 operates substantially similarly to the battery management system 140 with reference to FIG. 1. The battery monitor 230 may include various sensors positioned in and around a battery power source, including voltage, current, temperature, state of charge, and state of health sensors. The sensors can transmit their respective sensor data to the battery monitor 230 for analysis. Based on the analysis, the battery monitor 230 can predict when maintenance or replacements are needed and can request maintenance be performed on the battery power source.

In some implementations, the battery monitor 230 can monitor the battery power source and determine whether a battery discharge level exceeds a continuous rating for a predetermined amount of time. A battery discharge level can be measured to determine how much energy has been used from the battery power source and how much remains. As the voltage of the battery power source drops as it discharges, that drop can provide an estimate of its remaining charge. In some implementations, the battery monitor 230 can measure the battery discharge level of the battery power source using a voltage-based measurement. This method measures the voltage while the battery is under load. Other methods, including Coulomb Counting (Ah Counting), impedance spectroscopy, Kalman Filtering, and the like, can also be used to measure the battery discharge level.

In some implementations, the battery monitor 230 can transmit information to the power source orchestration system 200 that indicates that the battery power source can provide full and unrestricted power to the electrically powered equipment (e.g., the drawworks, top drive, mud pumps, and auxiliary equipment). In some implementations, the battery monitor 230 transmits the information regardless of the condition of the other power sources. For example, the generators may be offline, and the utility power source may be unavailable or limited.

In some implementations, the battery monitor 230 calculates the available power supplied by the battery power source at a given time. The calculation can be dynamic and continuously calculated based on the condition of the battery power source. For instance, if the battery charge is low, the battery monitor 230 may indicate that the battery power source may only provide additional power for a limited time. In another instance, if the battery power source requires conditioning, then the battery monitor 230 may indicate that no additional power is available.

The generator mode module 240 is a component of the power source orchestration system 200 that is configured to set the configuration of the generators associated with the drilling site. The configuration of the generators can include setting a base load mode where the generators receive a setpoint of operation. The setpoint can then be used by the generators to respond based on the setpoint and not on the demand changes on the electrical bus.

In some implementations, the generator mode module 240 is configured to adjust the generator setpoint based on the utility setpoint and/or the battery power source. The adjustment, or tuning, can be associated with a proportional gain, integral gain, and derivative gain. The proportional gain can determine the reaction to the current error, which can be the difference between the desired and actual value (e.g., voltage or frequency). The integral gain can address the accumulated error over time and may eliminate steady-state errors. The derivative gain can be a response to the rate of change in the error, providing damping to reduce overshooting and oscillation. The error can be either caused by the generator overshooting its setpoint or by the utility power source overshooting its setpoint.

In some implementations, the generator mode module 240 adjusts the generator setpoint when there are large step changes in utility demand or overall power demand from the drilling site. When the power demand drops suddenly, the generator mode module 240 can lower the generator setpoint to avoid exporting power to the utility. When the power demand increases suddenly, the generator mode module 240 can increase the generator setpoint to avoid having the utility power source overshoot its setpoint.

In some implementations, the generator mode module 240 sets a minimum allowable setpoint for the generators such that adjustments to the setpoint never fall below the minimum allowable setpoint, thereby avoiding the power output to near or approximate 0 kW. When generators operate at near 0 kW, issues such as generator circuit breaker protection mechanisms open the generator breakers. The minimum allowable setpoint can be set such that the generators avoid feeding power back to the utility but high enough to avoid the output nearing 0 kW.

The generator mode module 240 is further configured to prevent the generators from reverse powering. Reverse powering involves power flowing in the opposite direction from what is intended or designed. Instead of the generator supplying power to the power load or the utility power source, power flows back into the generator. This can occur due to synchronization issues, load shedding, generator failure, incorrect configurations, grid conditions, and the like. The generator mode module 240 may include reverse power relays, synchronization equipment, automatic voltage regulators, governor controls, and the like that are configured to avoid reverse powering of the generators while still maintaining the setpoint assigned to the generators.

The drill site activation mechanism 250 is a component of the power source orchestration system 200 configured to activate and deactivate electrically powered equipment at the drilling site. If the power source orchestration system 200 is unable to maintain the utility power source at or below its utility setpoint despite integrating either the battery power source, the generators, or both, then the drill site activation mechanism 250 can transmit a command to the drilling site to shed a specific amount of load such that the utility power source can lower to at least the utility setpoint.

Such instances can occur, as an example, when the battery power source is discharging at its max rate, and the generators are failing to come online fast enough, when the battery state of charge drops to a low level, and the generators fail to come online, equipment failure, response to other electrical or mechanical issues arise such that the power demand cannot be met adequately.

In some implementations, the drill site activation mechanism 250 allocates less power to equipment at the drilling site if the power orchestration system 200 is unable to maintain the utility power source at or below its utility setpoint. As the power demand causes the utility power draw to approach its utility setpoint, the drill site activation mechanism 250 can allocate a lower amount of power to the equipment to reduce the ramp rates of the tools. The lower amount of power can be based on the needs of the drill site during specific activities. If some tools are not required for a specific activity, the drill site activation mechanism 250 can reduce the power to those tools first and proceed accordingly until the power demand is reduced sufficiently. Based on the condition of the drilling site and the condition of the power sources, the drill site activation mechanism 250 can calculate the specific amount of load to shed. For instance, the drill site activation mechanism 250 can have the power draw from the various pieces of equipment, the current drilling operation being performed, the condition of the battery power source, the generators, and the utility power source. From that information, the drill site activation mechanism 250 can calculate what equipment can be shed to lower the power demand while avoiding shedding critically important equipment used in the current drilling operation.

The storage 260 stores information associated with the various components operating within a drilling site as well as any additional information generated by components of the disclosure to perform the embodiments described herein. For example, the storage 260 can store information, including battery data 262, drill site data 264, and power data 266.

It is noted that FIG. 2 is intended to depict the major representative components of a power source orchestration system 200. In some embodiments, however, individual components may have greater or lesser complexity than, as represented in FIG. 2, components other than or in addition to those shown in FIG. 2 may be present, and the number, type, and configuration of such components may vary.

### Example Power Management System

FIG. 3 illustrates an example of a power management system 300, in accordance with the embodiments of the present disclosure. As discussed, the techniques described herein optimize battery source utilization at a drilling site by automatically adjusting power draw from various power sources based on conditions at the site. In some implementations, the power management system 300 is a set of computerized systems and equipment that manages various aspects of power management associated with the drilling process.

As an example, the power management system 300 can provide power from power sources to portions of the drilling processes, enabling consistent and efficient operations. The power management system 300 can provide power to the drilling motors, top drives, draw works, mud pumps, and other critical components. Sensors throughout the rig can feed data back to the system for real-time tracking and adjustments. In some implementations, the power management system 300 can integrate with other monitoring and data logging systems, such as Measurement While Drilling (MWD) and Logging While Drilling (LWD), to provide a comprehensive overview of the drilling site. Operators can also use the power management system 300 to make precise power adjustments to the drilling site during the drilling process.

Accordingly, in some embodiments, a drilling operation can provide the drill site data 301 (i.e., the sensor data and contextual data associated with a drilling operation) to the power source orchestration system 200 to produce decisions on power source activations 320, including when to activate power sources based on the conditions of the drilling site. Based on the power activations 320, the power management system 300 can further provide additional calculations and analysis by utilizing the power source activations 320. As shown in FIG. 3, optionally, the power source orchestration system 200 is implemented as part of a power management system 300. Alternatively, the power source orchestration system 200 is implemented in a separate system that provides at least the power activations 320 to the power management system 300 to be evaluated by an operator.

Once the power activations 320, representing activations of potentially battery power sources, utility power sources, and generators, has been obtained by the power management system 300, the power activations 320 can be evaluated by the operator (e.g., administrator, field supervisor) or automatically applied to the drilling site. In some implementations, user input 302 (e.g., configuration preferences, additional contextual data) can be received by a rig control system 304 of the power management system 300. The user input 302 can include any information associated with a drilling operation that can be used by the power source orchestration system 200 when producing the power activations 320. The rig control system 304 can also generate rig controls 330, including drilling operations and electrically powered equipment used, and may include the power activations 320 produced by the power source orchestration system 200 as a result of evaluating the user input 302.

In some implementations, the resulting power activations 320 generated by the power source orchestration system 200 may be output to a different or downstream drilling system for evaluation and responsive action. The responsive action may take any known or later developed form, including output, to a field operator, such as via a user interface when the power activations 320 indicate necessary or recommended changes to the power for drilling operations due to the changing conditions by or to the equipment. The user interface may comprise user interface elements for drilling down into the details of the notification, including identifying the specific reference values and providing charts. In this way, the field operators may identify which factors contributed to the power demand and power activations recommended and make decisions based on their knowledge and expertise.

It is noted that FIG. 3 is intended to depict the major representative components of a power management system 300. In some embodiments, however, individual components may have greater or lesser complexity than, as represented in FIG. 3, components other than or in addition to those shown in FIG. 3 may be present, and the number, type, and configuration of such components may vary.

### Example Flow Diagrams

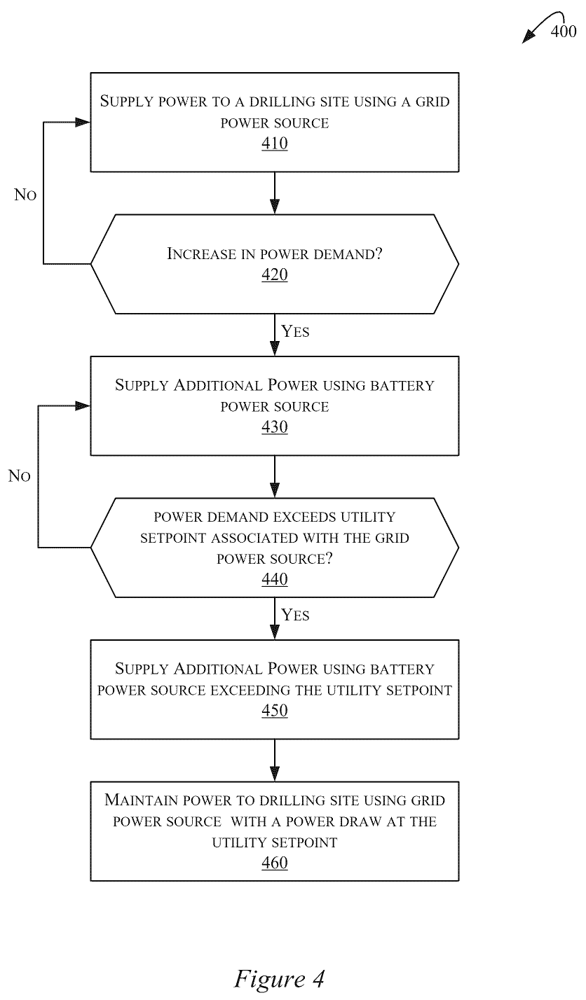

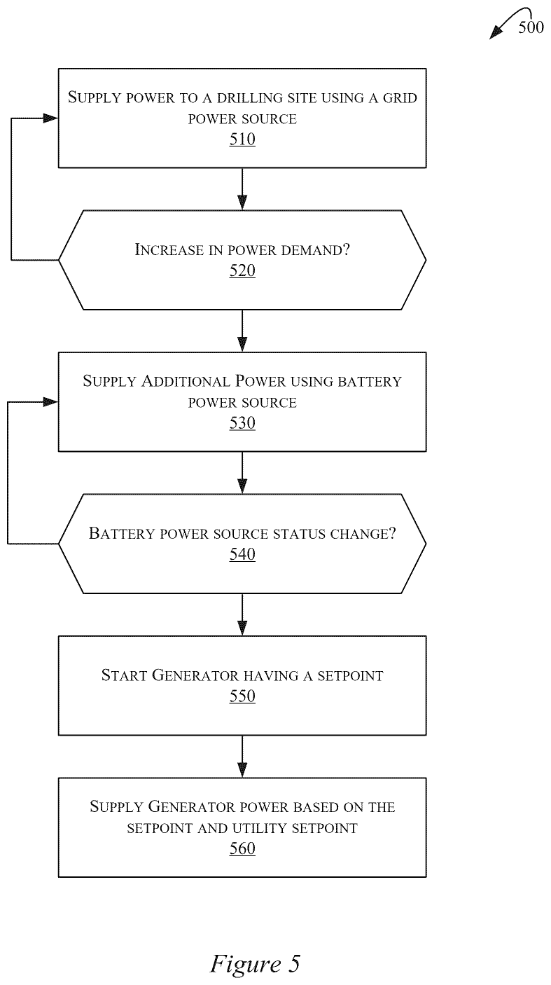

FIGS. 1-3, the corresponding text, and the examples provide a number of different systems that enable optimizing battery source utilization at a drilling site by automatically adjusting power draw from various power sources based on conditions at the site. In addition to the foregoing, embodiments can also be described in terms of flowcharts comprising acts and steps to accomplish a particular result. For example, FIGS. 4-5 illustrate flowcharts of exemplary methods in accordance with one or more embodiments. The methods described in relation to FIGS. 4-5 may be performed with fewer or more steps/acts, or the steps/acts may be performed in differing orders. Additionally, the steps/acts described herein may be repeated or performed in parallel with one another or in parallel with different instances of the same or similar steps/acts.

With reference to FIG. 4, a flow diagram illustrating a method is provided. Each block of the method 400 and any other methods described herein comprise a computing process performed using any combination of hardware, firmware, and/or software. For instance, in some embodiments, various functions are carried out by a processor executing instructions stored in memory. In some cases, the methods are embodied as computer-usable instructions stored on computer storage media. In some implementations, the methods are provided by a standalone application, a service or hosted service (standalone or in combination with another hosted service), or a plug-in to another product, to name a few.

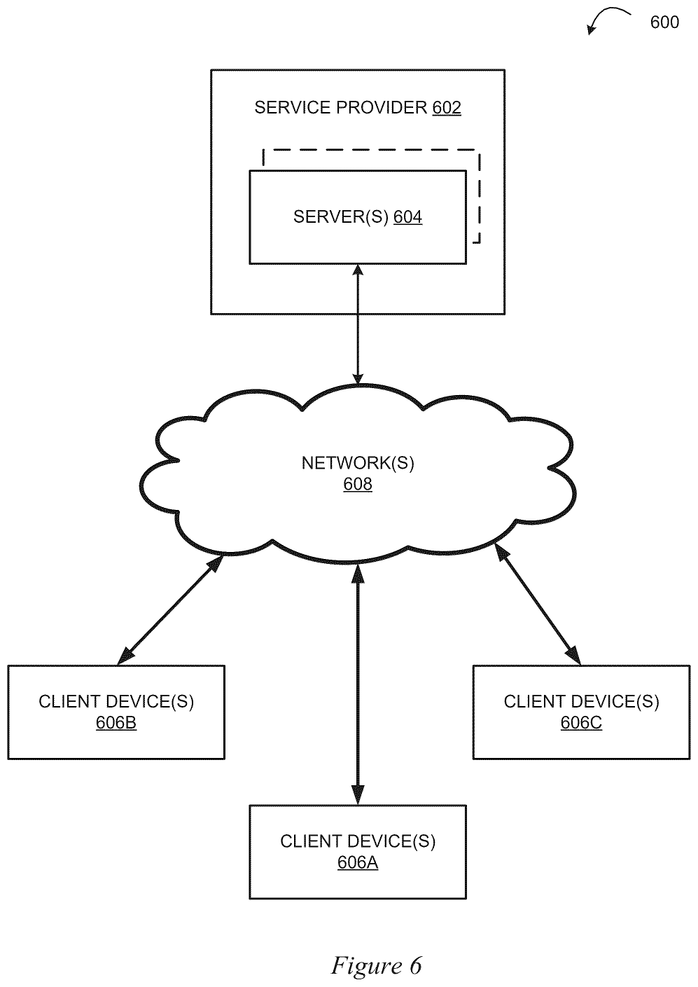

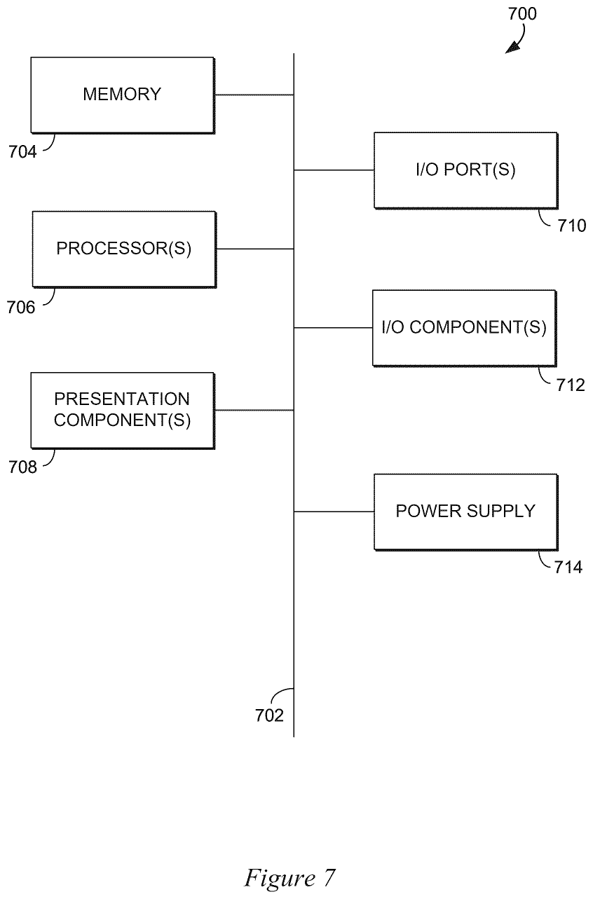

FIG. 4 shows a flowchart illustrating an example process 400 performable by or at a computing device (e.g., a power management system substantially similar to the power management system 130 of FIG. 1, a power source orchestration system similar to the power source orchestration system 200 of FIG. 2) that supports powering oil well drilling operations. The operations of the process 400 may be implemented by a computing device or its components as described herein. For example, the process 400 may be performed by a computing device, such as the computing device 700 described with reference to FIG. 7. In some examples, the process 400 may be performed within a computing environment such as the computing environment 600 described with reference to FIG. 6.

In some examples, the computing device is configured to perform the process 400, described with reference to FIG. 4. In block 410, the computing device supplies power to a drilling site using a utility power source. The utility power source includes a utility setpoint that may be set by a utility company providing the utility power. The utility setpoint can dictate the total power draw allowable for a drilling site to pull from the utility power source at a given time. Exceeding this limit may trigger power outages or cause damage to the power infrastructure.

In block 420, the computing device determines if there is an increase in power demand. The power demand can be determined by components such as the power detection module 210, which collects data associated with a drilling site and calculates the power demand at a given moment. In addition, the power demand can include a load ramp indicating the rate at which power demand increases or decreases over a specific period of time. As described, power meters can continuously measure the power consumption of the drilling site's equipment and systems, and the associated data can be collected by the power detection module 210 at regular intervals. If there is no increase in power demand, the computing device can continue to supply power from the utility power source as described in block 410. However, if there is an increase in power demand, the process 400 proceeds to block 430.

In block 430, the computing device supplies additional power to the drilling site using a battery power source. The amount of additional power provided by the battery power source can be associated with the load ramp and the utility setpoint. For instance, if the load ramp indicates that the power demand may result in demand that is greater than can be provided by the utility setpoint, then the additional power may correspond to the amount of power needed to avoid the utility power source exceeding the utility setpoint.

In block 440, the computing device determines whether the power demand will exceed the utility setpoint. As discussed, the load ramp may indicate that the power demand will exceed or have exceeded the utility setpoint. If the power demand will not exceed the utility setpoint, then the computing device can continue to supply power from the utility power source and additional power from the battery power source. However, if the computing device determines that the power demand will exceed or has exceeded the utility setpoint, then the process 400 proceeds to block 450.

In block 450, the computing device provides additional power from the battery power source to accommodate the excess power demand beyond the utility setpoint. In block 460, the computing device maintains power to the drilling site with a power draw set at the utility setpoint. Thus, the utility power source does not exceed the utility setpoint while the drilling site receives its required power demand.

In some implementations, the computing device receives battery information from the battery power source. The battery information can include a status and condition of the battery power source. The computing device can determine a battery utilization of the battery power source based on the battery information and an operation of the drilling site. Using battery utilization, the computing device can adjust the additional power from the battery power source to avoid operational issues with the battery power source.

In some implementations, the computing device detects a power demand of the drilling site exceeds a capacity threshold associated with the drilling site. The capacity threshold may indicate a maximum power draw allowable for a drilling site based on the conditions of the site and the power available to the site. The computing device can reduce the power demand of the drilling site by shedding a power load from equipment operating within the drilling site.

In some implementations, the computing device detects a power draw of the power to the drilling site using the utility power source within a threshold associated with the utility setpoint. The threshold may be set such that when the power draw from the drilling site reaches the threshold, then certain activities should be paused to avoid increasing the power draw any further. The computing device can then reduce the load ramp by reducing the power demand of the drilling site by shedding a power load from equipment operating within the drilling site.

In some implementations, similarly, the computing device detects a power draw from the power to the drilling site using the utility power source that exceeds the utility setpoint by a predetermined amount. In response, the computing device can reduce the power demand of the drilling site by shedding a power load from equipment operating within the drilling site.

FIG. 5 shows a flowchart illustrating an example process 500 performable by or at a computing device (e.g., a power management system substantially similar to the power management system 130 of FIG. 1, a power source orchestration system similar to the power source orchestration system 200 of FIG. 2) that supports powering oil well drilling operations. The operations of the process 500 may be implemented by a computing device or its components as described herein. For example, the process 500 may be performed by a computing device, such as the computing device 700 described with reference to FIG. 7. In some examples, the process 500 may be performed within a computing environment such as the computing environment 600 described with reference to FIG. 6.

In some examples, the computing device is configured to perform the process 500, described with reference to FIG. 5. In block 510, the computing device supplies power to a drilling site using a utility power source. The utility power source includes a utility setpoint that may be set by a utility company providing the utility power. The utility setpoint can dictate the total power draw allowable for a drilling site to pull from the utility power source at a given time. Exceeding this limit may trigger power outages or cause damage to the power infrastructure.

In block 520, the computing device determines if there is an increase in power demand. The power demand can be determined by components such as the power detection module 210, which collects data associated with a drilling site and calculates the power demand at a given moment. In addition, the power demand can include a load ramp indicating the rate at which power demand increases or decreases over a specific period of time. As described, power meters can continuously measure the power consumption of the drilling site's equipment and systems, and the associated data can be collected by the power detection module 210 at regular intervals. If there is no increase in power demand, the computing device can continue to supply power from the utility power source as described in block 510. However, if there is an increase in power demand, the process 500 proceeds to block 530.

In block 530, the computing device supplies additional power to the drilling site using a battery power source. The amount of additional power provided by the battery power source can be associated with the load ramp and the utility setpoint. For instance, if the load ramp indicates that the power demand may result in demand that is greater than can be provided by the utility setpoint, then the additional power may correspond to the amount of power needed to avoid the utility power source exceeding the utility setpoint.

In block 540, the computing device determines whether the battery power source has indicated a status change. The status change can indicate that the battery discharge level exceeds a continuous rating for a predetermined amount of time. This discharge level may indicate that, for safe operation, the battery power source may only discharge at that level for a limited amount of time as set by a manufacturer or operator and reflected by the predetermined amount of time. In another example, the status change may indicate that there is a state of charge associated with the additional power provided by the battery power source. The state of charge may indicate that the battery power source may be unable to continue providing additional power at the levels required to meet the power demand requested by the drilling site. If there is no status change, the computing device continues to provide additional power as described in block 530. However, if the computing device determines a status change has occurred, then the process 500 proceeds to block 550.

In block 550, the computing device starts a generator associated with the drilling site. Starting the generator may include configuring the generator in a base load mode that includes a setpoint for the generator. In block 560, the computing device can supply generator power based on its setpoint. In some implementations, the generator supplies power based on its setpoint, the load ramp of the power demand, and the utility setpoint.

In some implementations, the computing device detects a decrease in power demand associated with the drilling site. Based on the decrease in power demand, the computing device can adjust the setpoint of the generator based on the decrease in power demand associated with the drilling site. The adjusted setpoint avoids the exportation of the generator power to the utility power source. In some implementations, the computing device detects an increase in power demand associated with the drilling site. Based on the increase in power demand, the computing device adjusts the setpoint of the generator based on the increase in power demand associated with the drilling site. The adjusted setpoint avoids the power produced by the utility power source exceeding the utility setpoint.

### Example Computing Environment

FIG. 6 illustrates a schematic diagram of an exemplary computing environment 600 in which the power management system 130 or the power source orchestration system 200 can operate in accordance with one or more embodiments of the present disclosure. In one or more embodiments, the computing environment 600 includes a service provider 602, which may include one or more servers 604 connected to a plurality of client devices 606A-606C via one or more networks 608. The client devices 606A-606C, the one or more networks 608, the service provider 602, and the one or more servers 604 may communicate with each other or other components using any communication platforms and technologies suitable for transporting data and/or communication signals, including any known communication technologies, devices, media, and protocols supportive of remote data communications, examples of which will be described in more detail below with respect to FIG. 7.

Although FIG. 6 illustrates a particular arrangement of the client devices 606A-606C, the one or more networks 608, the service provider 602, and the one or more servers 604, various additional arrangements are possible. For example, the client devices 606A-606C may directly communicate with the one or more servers 604, bypassing the network 608. Or alternatively, the client devices 606A-606C may directly communicate with each other. The service provider 602 may be a public cloud service provider that owns and operates its own infrastructure in one or more data centers and provides this infrastructure to customers and end users on demand to host applications on the one or more servers 604. The servers may include one or more hardware servers (e.g., hosts), each with its own computing resources (e.g., processors, memory, disk space, networking bandwidth, etc.), which may be securely divided between multiple customers, each of which hosts their own applications on the one or more servers.

In some embodiments, the service provider may be a private cloud provider who maintains cloud infrastructure for a single organization. The one or more servers 604 may similarly include one or more hardware servers, each with its own computing resources, which are divided among applications hosted by the one or more servers for use by members of the organization or their customers.

Similarly, although the computing environment 600 of FIG. 6 is depicted as having various components, the computing environment 600 may have additional or alternative components. For example, the environment 600 can be implemented on a single computing device with the power management system 130. In particular, the power management system 130 may be implemented in whole or in part on the client device 606A.

As illustrated in FIG. 6, the environment 600 may include client devices 606A-606C. The client devices 606A-606C may comprise any computing device. For example, client devices 606A-606C may comprise one or more personal computers, laptop computers, mobile devices, mobile phones, tablets, special purpose computers, or other computing devices, including computing devices described below with regard to FIG. 7. Although three client devices are shown in FIG. 6, it will be appreciated that client devices 606A-606C may comprise any number of client devices (greater or smaller than shown).

Moreover, as illustrated in FIG. 6, the client devices 606A-606C and the one or more servers 604 may communicate via one or more networks 608. The one or more networks 608 may represent a single network or a collection of networks (such as the Internet, a corporate Intranet, a virtual private network (VPN), a local area network (LAN), a wireless local network (WLAN), a cellular network, a wide area network (WAN), a metropolitan area network (MAN), or a combination of two or more such networks. Thus, the one or more networks 608 may be any suitable network over which the client devices 606A-606N may access service provider 602 and server 604, or vice versa. The one or more networks 608 will be discussed in more detail below with regard to FIG. 7.

In addition, the environment 600 may also include one or more servers 604. The one or more servers 604 may generate, store, receive, and transmit any type of data or other information related to drilling operations. For example, a server 604 may receive data from a client device, such as the client device 606A, and send the data to another client device, such as the client device 602B and/or 602C. The server 604 can also transmit electronic messages between one or more users of the environment 600. In one example embodiment, the server 604 is a data server. The server 604 can also comprise a communication server or a web-hosting server. Additional details regarding the server 604 will be discussed below with respect to FIG. 7.

As mentioned, in one or more embodiments, the one or more servers 604 can include or implement at least a portion of the power management system 130 or the power source orchestration system 200 and can comprise an application running on the one or more servers 604, or a portion of the power management system 130 or the power source orchestration system 200 can be downloaded from the one or more servers 604. For example, the power source orchestration system 200 can include a web hosting application that allows the client devices 606A-606C to interact with content hosted at the one or more servers 604. To illustrate, in one or more embodiments of the environment 600, one or more client devices 606A-606C can access a webpage supported by the one or more servers 604. In particular, the client device 606A can run a web application (e.g., a web browser) to allow a user to access, view, and/or interact with a webpage or website hosted at the one or more servers 604.

Upon the client device 606A accessing a webpage or other web application hosted at the one or more servers 604, in one or more embodiments, the one or more servers 604 can provide access to sensor data or contextual associated with a drilling operation stored at the one or more servers 604. Moreover, the client device 606A can receive a request (i.e., via user input) to perform a power source activation and provide the request to the one or more servers 604. Upon receiving the request, the one or more servers 604 can automatically perform the methods and processes described above. The one or more servers 604 can provide all or portions of the power source activations to the client device 606A for display to the user. The one or more servers 604 can also host a power management application used to assess power management to an operator.

As just described, the power source orchestration system 200 may be implemented in whole, or in part, by the individual elements 602-608 of the computing environment 600. It will be appreciated that although certain components of the power source orchestration system 200 are described in the previous examples with regard to particular elements of the computing environment 600, various alternative implementations are possible. For instance, in one or more embodiments, the power source orchestration system 200 is implemented on any of the client devices 606A-C. Similarly, in one or more embodiments, the power source orchestration system 200 can be implemented on the one or more servers 604. Moreover, different components and functions of power source orchestration system 200 may be implemented separately among client devices 606A-606C, the one or more servers 604, and the network 608.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links that can be used to carry desired program code means in the form of computer-executable instructions or data structures and which can be accessed by a general-purpose or special-purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special-purpose computer, or special-purpose processing device to perform a certain function or group of functions. In some embodiments, computer-executable instructions are executed on a general-purpose computer to turn the general-purpose computer into a special-purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including personal computers, desktop computers, laptop computers, message processors, handheld devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the claims, a “cloud-computing environment” is an environment in which cloud computing is employed.

### Example Operating Environment

Having described an overview of embodiments of the present technology, an example operating environment in which embodiments of the present technology may be implemented is described in order to provide a general context for various aspects of the present technology. Referring now to FIG. 7, in particular, an exemplary operating environment for implementing embodiments of the present technology is shown and designated generally as computing device 700. Computing device 700 is but one example of a suitable computing environment and is not intended to suggest any limitation as to the scope of use or functionality of the technology. Neither should computing device 700 be interpreted as having any dependency or requirement relating to any one or combination of components illustrated.

The technology of the present disclosure may be described in the general context of computer code or machine-useable instructions, including computer-executable instructions such as program modules, being executed by a computer or other machines, such as a personal data assistant or other handheld devices. Generally, program modules, including routines, programs, objects, components, data structures, etc., refer to code that performs particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 7, computing device 700 includes bus 702 that directly or indirectly couples the following devices: memory 704, one or more processors 706, one or more presentation components 708, input/output ports 711, input/output components 712, and illustrative power supply 714. Bus 702 represents what may be one or more buses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component, such as a display device, or an I/O component. Also, processors have memory. We recognize that such is the nature of the art and reiterate that the diagram of FIG. 7 merely illustrates an example computing device that can be used in connection with one or more embodiments of the present technology. A distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable, and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 704 includes computer storage media in the form of volatile or nonvolatile memory. The memory may be removable, non-removable, or a combination thereof. Examples of hardware devices include solid-state memory, hard drives, optical-disc drives, etc. Computing device 700 includes one or more processors that read data from various entities, such as memory 704 or I/O components 712. Presentation component(s) 708 presents data indications to a user or other device. Examples of presentation components include a display device, speaker, printing component, vibrating component, etc.

I/O ports 710 allow computing device 700 to be logically coupled to other devices, including I/O components 720, some of which may be built in. Illustrative components include a microphone, joystick, game pad, satellite dish, scanner, printer, wireless device, sensors, etc.

Having identified various components in the present disclosure, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions, etc.) can be used in addition to or instead of those shown.

The subject matter of the present disclosure is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. For purposes of this disclosure, words such as “a” and “an,” unless otherwise indicated to the contrary, include the plural as well as the singular. Thus, for example, the requirement of “a feature” is satisfied where one or more features are present.

The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

The following embodiments represent exemplary embodiments of concepts contemplated herein. Any one of the following embodiments may be combined in a multiple dependent manner to depend from one or more other clauses. Further, any combination of dependent embodiments (e.g., clauses that explicitly depend from a previous clause) may be combined while staying within the scope of aspects contemplated herein. The following clauses are exemplary in nature and are not limiting.
Clause 1. A method of battery power source integration and utilization at a drilling site, the method including: supplying power to the drilling site using a utility power source, wherein the utility power source includes a utility setpoint, detecting an increase in a power demand to the drilling site, where the increase in the power demand includes a load ramp indicating a rate which the power demand increases over a period of time, and supplying additional power to the drilling site using a battery power source based, at least in part, on the load ramp and the utility setpoint. Thus, the illustrative embodiment provides technological improvements over conventional techniques by implementing a battery source into a drilling site and utilizing the battery source as power demand increases to meet such demand while also avoiding the utility power source from exceeding its utility setpoint.
Clause 2. The method of clause 1, further including: detecting the power demand associated with the drilling site exceeds the utility setpoint, supplying the additional power to the drilling site using the battery power source, where the additional power provides energy to the drilling site exceeding utility setpoint, and maintaining the power to the drilling site using the utility power source at the utility setpoint.
Clause 3. The method of clause 1-2, further including: detecting a state of charge in the additional power provided by the battery power source, starting a generator associated with an energy supply system of the drilling site, and supplying generator power produced by the generator to the drilling site based, at least in part, on the state of charge of the battery power source.
Clause 4. The method of clause 1-3, further including: determining a battery discharge level exceeds a continuous rating for a predetermined amount of time, starting a generator associated with an energy supply system of the drilling site, and supplying generator power produced by the generator to the drilling site based, at least in part, on the battery charge level exceeding the continuous rating for the predetermined amount of time.
Clause 5. The method of clause 1-4, further including: determining a power generation provided by the utility power source and the generator exceeds capacity on the drilling site for a second predetermined amount of time, and shutting down the generator, wherein the generator stops supplying the generator power to the drilling site.
Clause 6. The method of claim of clause 1-5, further including: determining the battery power source is unavailable to provide the additional power to the drilling site, starting a generator associated with an energy supply system of the drilling site, and supplying generator power to the drilling site using the generator based, at least in part, on the load ramp and the utility setpoint.
Clause 7. The method of clause 1-6, further including: starting a generator associated with an energy supply system of the drilling site, operating the generator in a base load mode, where the base load mode includes a setpoint, supplying generator power to the drilling using the generator based, at least in part, on the setpoint, detecting a decrease in power demand associated with the drilling site, and adjusting the setpoint of the generator based on the decrease in power demand associated with the drilling site, where the setpoint avoids exportation of the generator power to the utility power source.
Clause 8. The method of clause 1-7, further including: starting a generator associated with an energy supply system of the drilling site, operating the generator in a base load mode, wherein the base load mode includes a setpoint, supplying generator power to the drilling using the generator based, at least in part, on the setpoint, detecting an increase in power demand associated with the drilling site, and adjusting the setpoint of the generator based on the increase in power demand associated with the drilling site, where the setpoint avoids the power produced by the utility power source exceeding the utility setpoint.
Clause 9. The method of clause 1-8, where the setpoint associated with the generator is provided by a power management system of the drilling site.
Clause 10. The method of clause 1-9, where operating the generator includes setting a minimum setpoint, wherein the minimum setpoint avoids degradation of the generator during operation.
Clause 11. The method of clause 1-10, further including: receiving battery information from the battery power source, where the battery information includes a status and condition of the battery power source, determining a battery utilization of the battery power source based on the battery information and an operation of the drilling site, and adjusting the additional power from the battery power source based on the battery utilization.
Clause 12. The method of clause 1-11, further including: detecting a power demand of the drilling site exceeds a capacity threshold associated with the drilling site, and reducing the power demand of the drilling site by shedding a power load from equipment operating within the drilling site.
Clause 13. The method of clause 1-12, further including: detecting a power draw of the power to the drilling site using the utility power source is within a threshold associated with the utility setpoint, and reducing the load ramp by reducing the power demand of the drilling site by shedding a power load from equipment operating within the drilling site. In some implementations, the method reduces the power demand of the drilling site by allocating a lower amount of power to the equipment operating within the drilling site.
Clause 14. The method of clause 1-13, further including: detecting a power draw from the power to the drilling site using the utility power source exceeds the utility setpoint by a predetermined amount, and reducing the power demand of the drilling site by shedding a power load from equipment operating within the drilling site.
Clause 15. A power management system for battery power source integration and utilization at a drilling site, including: a processing system that includes one or more processors and one or more memories coupled with the one or more processors, the processing system configured to cause the device charger to supply power to the drilling site using a utility power source, wherein the utility power source includes a utility setpoint, detect an increase in a power demand to the drilling site, where the increase in the power demand includes a load ramp indicating a rate which the power demand increases over a period of time, and supply additional power to the drilling site using a battery power source based, at least in part, on the load ramp and the utility setpoint. Thus, the illustrative embodiment provides technological improvements over conventional techniques by implementing a battery source into a drilling site and utilizing the battery source as power demand increases to meet such demand while also avoiding the utility power source from exceeding its utility setpoint.
Clause 16. The power management system of clause 15, the processing system further configured to cause the power management system to: detect the power demand associated with the drilling site exceeds the utility setpoint, supply the additional power to the drilling site using the battery power source, wherein the additional power provides energy to the drilling site exceeding utility setpoint, and maintain the power to the drilling site using the utility power source at the utility setpoint.
Clause 17. The power management system of clause 15-16, the processing system further configured to cause the power management system to: determine a battery discharge level exceeds a continuous rating for a predetermined amount of time, start a generator associated with an energy supply system of the drilling site, and supply generator power produced by the generator to the drilling site based, at least in part, on the battery charge level exceeding the continuous rating for the predetermined amount of time.
Clause 18. The power management system of clause 15-17, the processing system further configured to cause the power management system to: determine the battery power source is unavailable to provide the additional power to the drilling site, start a generator associated with an energy supply system of the drilling site, and supply generator power to the drilling site using the generator based, at least in part, on the load ramp and the utility setpoint.
Clause 19. The power management system of clause 15-18, the processing system further configured to cause the power management system to: start a generator associated with an energy supply system of the drilling site, operate the generator in a base load mode, where the base load mode includes a setpoint, supply generator power to the drilling using the generator based, at least in part, on the setpoint, detect a decrease in power demand associated with the drilling site, and adjust the setpoint of the generator based on the decrease in power demand associated with the drilling site, where the setpoint avoids exportation of the generator power to the utility power source.
Clause 20. A non-transitory computer readable medium storing computer readable program code for operating a power management system battery power source integration and utilization at a drilling site, the power management system, wherein the computer readable program code causes a computer system to: supply power to the drilling site using a utility power source, wherein the utility power source includes a utility setpoint, detect an increase in a power demand to the drilling site, wherein the increase in the power demand includes a load ramp indicating a rate which the power demand increases over a period of time, and supply additional power to the drilling site using a battery power source based, at least in part, on the load ramp and the utility setpoint. Thus, the illustrative embodiment provides technological improvements over conventional techniques by implementing a battery source into a drilling site and utilizing the battery source as power demand increases to meet such demand while also avoiding the utility power source from exceeding its utility setpoint.

What is claimed is:

1. A method of battery power source integration and utilization at a drilling site, the method comprising:
supplying power to the drilling site using a utility power source, wherein the utility power source includes a utility setpoint;
detecting an increase in a power demand to the drilling site, wherein the increase in the power demand includes a load ramp indicating a rate which the power demand increases over a period of time; and
supplying additional power to the drilling site using a battery power source based, at least in part, on the load ramp and the utility setpoint.

2. The method of claim 1, further comprising:
detecting the power demand associated with the drilling site may exceed the utility setpoint;
supplying the additional power to the drilling site using the battery power source, wherein the additional power provides energy to the drilling site exceeding the utility setpoint; and
maintaining the power to the drilling site using the utility power source with a power draw at the utility setpoint.

3. The method of claim 2, further comprising:
detecting a state of charge in the additional power provided by the battery power source;
starting a generator associated with an energy supply system of the drilling site; and
supplying generator power produced by the generator to the drilling site based, at least in part, on the state of charge of the battery power source.

4. The method of claim 2, further comprising:
determining a battery discharge level may exceed a continuous rating for a predetermined amount of time;
starting a generator associated with an energy supply system of the drilling site; and
supplying generator power produced by the generator to the drilling site based, at least in part, on the battery discharge level exceeding the continuous rating for the predetermined amount of time.

5. The method of claim 3, further comprising:
determining a power generation capacity provided by the utility power source and the generator exceeds required capacity on the drilling site for a second predetermined amount of time; and
shutting down the generator, wherein the generator stops supplying the generator power to the drilling site.

6. The method of claim of claim 1, further comprising:
determining the battery power source is unavailable to provide the additional power to the drilling site;
starting a generator associated with an energy supply system of the drilling site; and
supplying generator power to the drilling site using the generator based, at least in part, on the load ramp and the utility setpoint.

7. The method of claim 1, further comprising:
starting a generator associated with an energy supply system of the drilling site;
operating the generator in a base load mode, wherein the base load mode includes a setpoint;
supplying generator power to the drilling site using the generator based, at least in part, on the setpoint;
detecting a decrease in the power demand associated with the drilling site; and
adjusting the setpoint of the generator based on the decrease in the power demand associated with the drilling site, wherein the setpoint avoids exportation of the generator power to the utility power source.

8. The method of claim 1, further comprising:
starting a generator associated with an energy supply system of the drilling site;
operating the generator in a base load mode, wherein the base load mode includes a setpoint;
supplying generator power to the drilling site using the generator based, at least in part, on the setpoint;
detecting an increase in the power demand associated with the drilling site; and
adjusting the setpoint of the generator based on the increase in the power demand associated with the drilling site, wherein the setpoint avoids the power produced by the utility power source exceeding the utility setpoint.

9. The method of claim 7, wherein the setpoint associated with the generator is provided by a power management system of the drilling site.

10. The method of claim 7, wherein operating the generator includes setting a minimum setpoint, wherein the minimum setpoint prevents the generator from activating reverse power protections and tripping the generator into an offline state.

11. The method of claim 1, further comprising:
receiving battery information from the battery power source, wherein the battery information includes a status and condition of the battery power source;
determining a battery utilization of the battery power source based on the battery information and an operation of the drilling site; and
adjusting the additional power from the battery power source based on the battery utilization.

12. The method of claim 1, further comprising:
detecting a power demand of the drilling site exceeds a capacity threshold associated with the drilling site; and
reducing the power demand of the drilling site by shedding a power load from equipment operating within the drilling site.

13. The method of claim 1, further comprising:
detecting a power draw of the power to the drilling site using the utility power source is within a threshold associated with the utility setpoint; and
reducing the load ramp by reducing the power demand of the drilling site.

14. The method of claim 1, further comprising:
detecting a power draw from the power to the drilling site using the utility power source may exceed the utility setpoint by a predetermined amount; and
reducing the power demand of the drilling site by shedding a power load from equipment operating within the drilling site.

15. A power management system for battery power source integration and utilization at a drilling site, comprising:
a processing system that includes one or more processors and one or more memories coupled with the one or more processors, the processing system configured to cause the power management system to:
supply power to the drilling site using a utility power source, wherein the utility power source includes a utility setpoint;
detect an increase in a power demand to the drilling site, wherein the increase in the power demand includes a load ramp indicating a rate which the power demand increases over a period of time; and
supply additional power to the drilling site using a battery power source based, at least in part, on the load ramp and the utility setpoint.

16. The power management system of claim 15, the processing system further configured to cause the power management system to:
detect the power demand associated with the drilling site may exceed the utility setpoint;
supply the additional power to the drilling site using the battery power source, wherein the additional power provides energy to the drilling site exceeding utility setpoint; and
maintain the power to the drilling site using the utility power source at the utility setpoint.

17. The power management system of claim 16, the processing system further configured to cause the power management system to:
determine a battery discharge level exceeds a continuous rating for a predetermined amount of time;
start a generator associated with an energy supply system of the drilling site; and
supply generator power produced by the generator to the drilling site based, at least in part, on the battery discharge level exceeding the continuous rating for the predetermined amount of time.

18. The power management system of claim 15, the processing system further configured to cause the power management system to:
determine the battery power source is unavailable to provide the additional power to the drilling site;
start a generator associated with an energy supply system of the drilling site; and
supply generator power to the drilling site using the generator based, at least in part, on the load ramp and the utility setpoint.

19. The power management system of claim 15, the processing system further configured to cause the power management system to:
start a generator associated with an energy supply system of the drilling site;
operate the generator in a base load mode, wherein the base load mode includes a setpoint;
supply generator power to the drilling site using the generator based, at least in part, on the setpoint;
detect a decrease in the power demand associated with the drilling site; and
adjust the setpoint of the generator based on the decrease in the power demand associated with the drilling site, wherein the setpoint avoids exportation of the generator power to the utility power source.

20. A non-transitory computer readable medium storing computer readable program code for operating a power management system for battery power source integration and utilization at a drilling site, the power management system, wherein the computer readable program code causes a computer system to:
supply power to the drilling site using a utility power source, wherein the utility power source includes a utility setpoint;
detect an increase in a power demand to the drilling site, wherein the increase in the power demand includes a load ramp indicating a rate which the power demand increases over a period of time; and
supply additional power to the drilling site using a battery power source based, at least in part, on the load ramp and the utility setpoint.
